(19) United States
(12) Patent Application Publication
(10) Pub. No.: US 2015/0249417 A1
(43) Pub. Date: Sep. 3, 2015

(54) SYNCHRONOUS GENERATOR CONTROLLER BASED ON FLUX OPTIMIZER

(71) Applicant: Rolls-Royce Corporation, Indianapolis, IN (US)

(72) Inventors: Paul Rancuret, Indianapolis, IN (US); Kaushik Rajashekara, Murphy, TX (US); John T. Alt, Zionsville, IN (US)

(21) Appl. No.: 14/579,198

(22) Filed: Dec. 22, 2014

Related U.S. Application Data
(60) Provisional application No. 61/921,974, filed on Dec. 30, 2013.

(51) Int. Cl. H02P 21/10; H02P 21/00; H02P 9/30

(52) U.S. Cl. CPC H02P 21/10; H02P 9/305; H02P 21/0035

(57) ABSTRACT

A control method for a synchronous generator system is disclosed including performing a first parametric optimization to determine a desired stator current angle assuming fixed stator current magnitude and fixed field current magnitude. A second parametric optimization is then performed to determine a desired field current magnitude assuming fixed stator current magnitude and fixed stator current angle. A desired stator current magnitude is calculated using the desired stator current angle and the desired field current magnitude. Finally, the desired stator current magnitude, the desired stator current angle and the desired field current magnitude are output.

### CROSS-REFERENCE TO RELATED APPLICATIONS

This application claims priority to U.S. Provisional Patent Application No. 61/921,974, filed Dec. 30, 2013, the contents of which are hereby incorporated in their entirety.

### FIELD OF TECHNOLOGY

An improved an integrated design and control of a synchronous generator is disclosed. More particularly, a method for providing flux regulation while minimizing losses due to electrical impedance is disclosed.

### BACKGROUND

Synchronous generators are utilized in a variety of industries and for a variety of applications. Their use in propulsion systems such as in aircraft commonly comprises providing power for engine starting as well as electrical power generation for systems operations. The electrical power demands of aircraft, as well as other transportation modes, are continually increasing as industries move to greater electronic control.

Traditional synchronous generators have a generator output that is controlled mainly by excitation voltage control. Traditional excitation voltage control may result in poor regulation of voltage and power factor in the presence of varying frequency and voltage. Modern operations require a well-regulated power converter irrespective of load variations, speed variations and operating conditions. Traditional excitation voltage control is not well suited to handle such variations. Additionally, the use of a fully controlled rectifier allows the controller to manipulate the vector of stator currents independently, as opposed to using passive rectification. The application of this vector control allows for finer tuning of the magnetic field, in such a way that can provide efficiency benefits.

Overcoming these concerns would be desirable, could improve generator efficiency, and could minimize the amount of losses due to electrical impedance.

### BRIEF DESCRIPTION OF THE DRAWINGS

While the claims are not limited to a specific illustration, an appreciation of the various aspects is best gained through a discussion of various examples thereof. Referring now to the drawings, exemplary illustrations are shown in detail. Although the drawings represent the illustrations, the drawings are not necessarily to scale and certain features may be exaggerated to better illustrate and explain an innovative aspect of an example. Further, the exemplary illustrations described herein are not intended to be exhaustive or otherwise limiting or restricted to the precise form and configuration shown in the drawings and disclosed in the following detailed description. Exemplary illustrations are described in detail by referring to the drawings as follows:

FIG. 1 is a schematic illustration of a synchronous generator control system, according to one example; and

FIG. 2 is an illustration of a flux optimization control for use with the synchronous generator control system illustrated in FIG. 1.

### DETAILED DESCRIPTION

An exemplary synchronous generator control system is described herein and is shown in the attached drawings. As aircraft design moves towards increasing quantity of electrical components and the resulting increase in electrical load, a system that can meet these high power demands while responding quickly to power generation needs is necessary. The present disclosure describes such a system. In addition, the present disclosure describes a method of regulating power in the presence of load variations, speed variations, and varied operating conditions. The synchronous generator control system controls flux levels used within field orientation control to minimize machine losses.

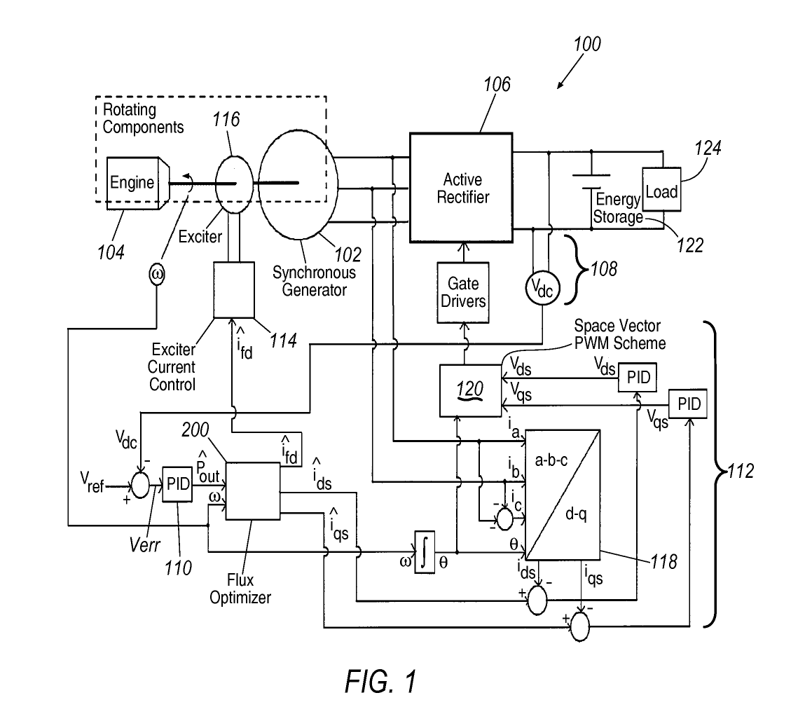

FIG. 1 illustrates a synchronous generator control system 100 including a synchronous generator 102 driven by a power plant or engine 104. In one embodiment, it is contemplated that the power plant 104 is an aircraft gas turbine. The synchronous generator 102 output is rectified using an active rectifier 106 to provide power to a DC bus 108. The DC bus voltage error Vₑᵣᵣ is the difference between the bus voltage V_{dc} and the desired bus voltage V_{ref}. The DC bus voltage error Vₑᵣᵣ is utilized as an input into a PID controller 110. The PID controller 110 provides a desired output power value Pₒᵤₜ, which the synchronous generator 102 should produce to maintain the bus voltage. The desired output power value Pₒᵤₜ (or alternately the desired output torque value Tₒᵤₜ) as well as the measured speed w are inputs into the flux optimization control 200 that will be described in greater detail below. The outputs of the flux optimization control 200 include desired stator current i_{qs}, i_{ds} and desired field current magnitude i_{fd}. These outputs are sent to an inner loop current controller 112 as well as a field excitation controller 114. The inner loop current controller 112 provides switching laws for the active rectifier 106 causing the machine stator currents to track the desired currents. The field excitation controller 112 controls the exciter 116 to ensure the desired field current i_{fd} is achieved in the field winding.

The generator control system 100 may also include a variety of additional components and controls such as, but not limited to, an algebraic transform control 118 for conversion between the a-b-c frame and the q-d frame, some form of PWM scheme 120 such as space vector modulation, an energy storage 122 and an energy load 124. It is contemplated that the energy load 124 may encompass any or all of the electrical needs of an aircraft or other system. It would be understood that the overall scheme could be modified and adapted by one skilled in the art in light of the present disclosure. It is contemplated that the flux optimization control 200 could be implemented in a variety of varied layouts and control schemes.

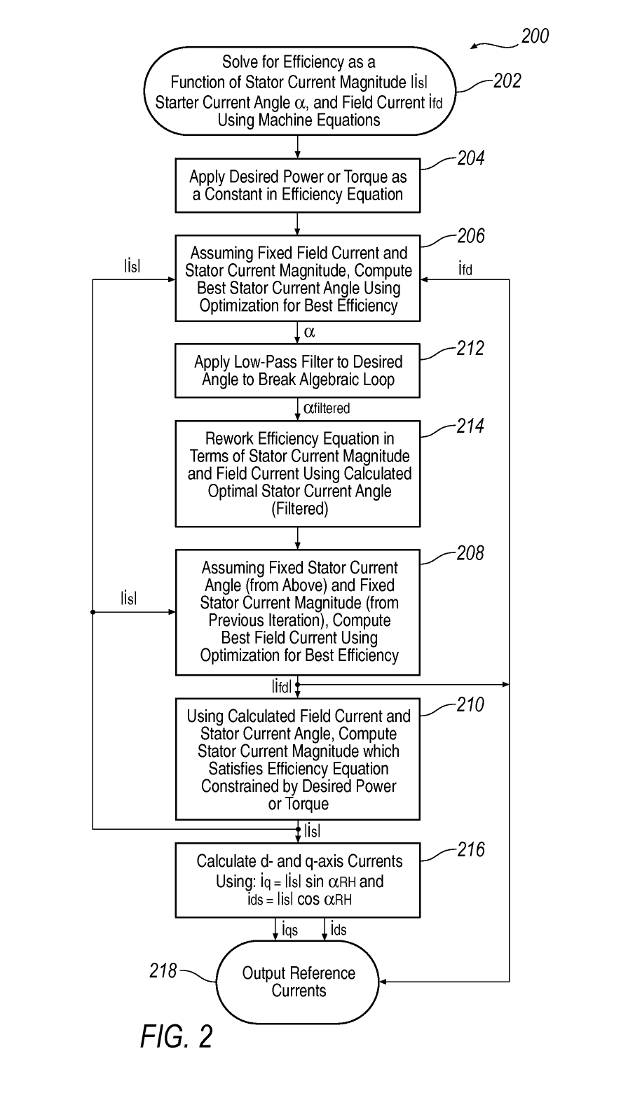

FIG. 2 illustrates the flux optimization control 200 in accordance with one embodiment of the present disclosure. The flux optimization control 200 begins by performing a first machine efficiency equation 202 which solves for efficiency as a function of the stator current magnitude |iₛ|, the stator current angle α, and the field current magnitude i_{fd} and outputs a fixed stator current magnitude, a fixed stator current angle and a fixed field current magnitude. A constraint equation 204 is then performed utilizing either the desired power or torque (Pₒᵤₜ or Tₒᵤₜ) as a constraint in the efficiency equation. A first parametric optimization 206 is then executed assuming a fixed stator current magnitude |iₛ| and a fixed field current magnitude i_{fd} in order to calculate a desired stator current angle α for efficiency. A second parametric optimization 208 is executed assuming a fixed stator current magnitude |iₛ| and a fixed stator current angle α in order to calculate a desired field current magnitude i_{fd}. The calculated desired field current magnitude i_{fd} is looped back to the first parametric optimization 206 for use as the fixed field current magnitude. In addition, the calculated desired field current magnitude along with the desired stator current angle α are passed to an algebraic machine equation 210 where they are used to calculated a desired stator current magnitude |iₛ|. The desired stator current magnitude |iₛ| is looped back to the first parametric optimization 206 for use as the fixed stator current magnitude |iₛ|. In this fashion, the first parametric optimization 206 and the second parametric optimization 208 operate in a looped arrangement.

In order to resolve this algebraic loop, the disclosure contemplated the use of an algebraic loop breaking step 212 positioned after the first parametric optimization 206. The algebraic loop breaking step 212 is contemplated to embody any mathematical arrangement that will act to resolve the loop quickly. In at least one contemplated embodiment, it is contemplated that the algebraic loop breaking step comprises a stable low-pass filter. The algebraic loop breaking step 212 produces a filtered desired stator current angle α. In addition, the control 200 may also include a second efficiency equations step 214 prior to the second parametric optimization 208. The second efficiency equation 214 solves efficiency in terms of stator current magnitude |iₛ| and stator current angle α. The second efficiency equation 214, within the looped arrangement, further improves the flux optimization response time.

The looped portions of the control 200 continually produces a desired stator current magnitude |iₛ|, a desired stator current angle α, and a desired field current magnitude i_{fd}. The desired stator current magnitude |iₛ| and the desired stator current angle α are utilized in calculation step 216 to calculate a stator i_{qs} and i_{ds} values which along with the desired field current magnitude i_{fd} are continually output in an output step 218 to the inner loop current controller 112 as well as the field excitation controller 114. The dual looped optimization ensures that the voltage quickly reaches and maintains proper bus voltage while minimizing the copper resistive losses of the synchronous generator 102. It will be understood that one skilled in the art would recognize a variety of alterations or modifications in light of the present disclosure.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

What is claimed is:

1. A control method for a synchronous generator system comprising the steps of:
performing a first parametric optimization to determine a desired stator current angle assuming fixed stator current magnitude and fixed field current magnitude;
performing a second parametric optimization to determine a desired field current magnitude assuming fixed stator current magnitude and fixed stator current angle;
calculating a desired stator current magnitude using said desired stator current angle and said desired field current magnitude; and
outputting said desired stator current magnitude, said desired stator current angle and said desired field current magnitude.

2. A control method for a synchronous generator system as claimed in claim 1, wherein said first parametric optimization and said second parametric optimization are in a looped arrangement.

3. A control method for a synchronous generator system as claimed in claim 1, further comprising:
performing a first machine efficiency equation prior to said first parametric optimization to determine said fixed stator current magnitude, said fixed stator current angle and said fixed field current magnitude; and
performing a constraint equation to determine a desired output power value.

4. A control method for a synchronous generator system as claimed in claim 1, further comprising:
performing an algebraic loop breaking step to resolve said first parametric optimization and said second parametric optimization.

5. A control method for a synchronous generator system as claimed in claim 4, wherein said algebraic loop breaking step comprises a low-pass filter.

6. A control method for a synchronous generator system as claimed in claim 1, further comprising:
converting said desired stator current magnitude and said desired stator current angle to a q-axis current value and a d-axis current value.

7. A control method for a synchronous generator system as claimed in claim 3, further comprising:
performing a second machine efficiency equation using said desired stator current magnitude and said desired stator current angle to verify said first machine efficiency equation.

8. A control method for a synchronous generator system comprising the steps of:
performing a first machine efficiency equation prior to said first parametric optimization to determine a fixed stator current magnitude, a fixed stator current angle and a fixed field current magnitude;
performing a constraint equation;
performing a first parametric optimization to determine a desired stator current angle assuming said fixed stator current magnitude and said fixed field current magnitude;
performing a second parametric optimization to determine a desired field current magnitude assuming said fixed stator current magnitude and a fixed stator current angle;
calculating a desired stator current magnitude using said desired stator current angle and said desired field current magnitude;
looping said first parametric optimization and said second parametric optimization;
outputting said desired stator current magnitude, said desired stator current angle and said desired field current magnitude.

9. A control method for a synchronous generator system as claimed in claim 8, further comprising:
performing a second machine efficiency equation using said desired stator current magnitude and said desired stator current angle to verify said first machine efficiency equation.

10. A control method for a synchronous generator system as claimed in claim 8, further comprising:
performing an algebraic loop breaking step to resolve said first parametric optimization and said second parametric optimization.

11. A control method for a synchronous generator system as claimed in claim 10, wherein said algebraic loop breaking step comprises a low-pass filter.

12. A control method for a synchronous generator system as claimed in claim 8, further comprising:
converting said desired stator current magnitude and said desired stator current angle to a q-axis current value and a d-axis current value.

13. A control method for a synchronous generator system as claimed in claim 8, wherein said constraint equation determines a desired output power value.

14. A control method for a synchronous generator system as claimed in claim 8, wherein said constraint equation determines a desired output torque value.

15. A synchronous generator control system comprising:
a synchronous generator;
an active rectifier in communication with said synchronous generator;
an exciter current control in communication with said synchronous generator; and
a flux optimizer controller in communication with said excited current control, said flux optimizer controller configured to:
perform a first parametric optimization to determine a desired stator current angle assuming fixed stator current magnitude and fixed field current magnitude;
perform a second parametric optimization to determine a desired field current magnitude assuming fixed stator current magnitude and fixed stator current angle;
calculate a desired stator current magnitude using said desired stator current angle and said desired field current magnitude; and
output said desired stator current magnitude, said desired stator current angle and said desired field current magnitude.

16. A synchronous generator control system as claimed in claim 15, wherein said flux optimizer controller is further configured to:
loop said first parametric optimization and said second parametric optimization.

17. A synchronous generator control system as claimed in claim 15, wherein said flux optimizer controller is further configured to:
perform an algebraic loop breaking step to resolve said first parametric optimization and said second parametric optimization.

18. A synchronous generator control system as claimed in claim 17, further comprising:
a low-pass filter configured to perform said algebraic loop breaking step.

19. A synchronous generator control system as claimed in claim 15, wherein said flux optimizer controller is further configured to:
perform a first machine efficiency equation prior to said first parametric optimization to determine said fixed stator current magnitude, said fixed stator current angle and said fixed field current magnitude; and
perform a constraint equation.

20. A synchronous generator control system as claimed in claim 19, wherein said flux optimizer controller is further configured to:
perform a second machine efficiency equation using said desired stator current magnitude and said desired stator current angle to verify said first machine efficiency equation.
